(19) United States
(12) Patent Application Publication
(10) Pub. No.: US 2004/0267654 A1
(43) Pub. Date: Dec. 30, 2004

(54) Candlestick and bar charts

(76) Inventors: Huei Peng, Fremont, CA (US); Bo Peng, Gilbert, AZ (US)

Correspondence Address: Huei Peng, 35964 Vivian PL, Fremont, CA, 94536, US

(21) Appl. No.: 10/607,323

(22) Filed: Jun. 26, 2003

(51) Int. Cl. G06F 17/60

(52) U.S. Cl. 705/37

(57) ABSTRACT

New bar and candlestick charts with a price mark for a pre-determined period of time before the market closing (called B-closing price) and with a price mark for a pre-determined period of time after the market opening (called A-opening price) are disclosed. A-opening price and B-closing price show the price trend of a security for a short period of time before the market closing and reflect the sequence of events of a security between the open and close of the market.

### BACKGROUND OF THE INVENTION

(1) Field of the Invention

The present invention relates to a new type of candlestick and bar charts and the like in the technical analysis of securities. The new candlestick and bar charts are visually appealing, easier to interpret, and providing more information of the price trend for a short period of time before the market closes.

(2) Prior Art

The candlestick and bar charts are well known in the prior art and commonly used in technical analysis of securities. A candlestick chart, as shown in FIG. 1a and FIG. 1b, is formed using of opening price (12), highest price (10), lowest price (17), and closing price (13) of a security in a trading period. If the closing price is higher than the opening price, then a hollow candlestick (14), usually displayed as white, is drawn. If the closing price is lower than the opening price, then a filled candlestick (15), usually displayed as black, is drawn. The hollow or filled portion of the candlestick is called the real body (also referred to as the “body”). The thin lines above and below the real body represent the high and low range of the stock price and are called shadows (also referred to as wicks and tails). The highest price (10) is marked by the top of the upper shadow (11) and the lowest price (17) is marked by the bottom of the lower shadow (16).

There are varieties of prior art discussing candlestick chart. Those prior art include a book: “Technical Analysis From A to Z” by Steven B. Achelis and an article on internet: “Introduction to Candlesticks” on www.stockcharts.com,

However the candlestick and bar charts do not show the price trend of the short period of time before the market closing and not reflect the sequence of events between the opening price and the closing price of a security. It is important to display the price trend for a short period of time before the market closing. The price trend of a short period of time, for example half hour, before the market closes will influence the next day's opening price unless there is an event takes place after market closes.

Therefore a new type of candlestick and bar charts are needed to provide information of the price trend of a security within a short period of time before the market closing and sequence of events between the opening price and the closing price of a security.

### BRIEF SUMMARY OF THE INVENTION

In the present invention, (1) candlestick and bar charts and the like with a price mark of a pre-determined period of time before the market closing, called B-closing price, are disclosed; (2) candlestick and bar charts and the like with a price mark of a pre-determined period of time after the market opening, called A-opening price, are disclosed; (3) candlestick and bar charts and the like with both B-closing price and A-opening price are disclosed.

The primary object of the present invention is to provide a new type of candlestick and bar charts such that the charts will show the price trend of a security for a short period of time before the market closes.

The second object of this invention is to provide a new type of candlestick and bar charts such that traders will find useful information of events happened after the market opening and before the market closing.

Further objects and advantages of the present invention will become apparent from a consideration of the ensuing description and drawings. More advantages will become obvious when combining the new candlestick and bar charts with well-known patterns, such as Hammer and Hanging Man, Inverted Hammer, Shooting star, Blending Candles, Harami Position, Doji, Marubozu, Spinning Tops, etc.

### BRIEF DESCRIPTION OF THE SEVERAL VIEWS OF DRAWINGS

The novel features believed characteristic of the present invention are set forth in the claims. The invention itself, as well as other features and advantages thereof will be best understood by referring to detailed descriptions that follow, when read in conjunction with the accompanying drawings, wherein:

FIG. 1a shows a candlestick chart of prior art with white real body.

FIG. 1b shows a candlestick chart of prior art with black real body.

FIG. 2a shows a candlestick chart with white real body and B-closing price above the white real body.

FIG. 2b shows a candlestick chart with black real body and B-closing price above the black real body.

FIG. 3a shows a candlestick chart with white real body and B-closing price inside the white real body.

FIG. 3b shows a candlestick chart with black real body and B-closing price inside the black real body.

FIG. 4a shows a candlestick chart with white real body and B-closing price below the white real body.

FIG. 4b shows a candlestick chart with black real body and B-closing price below the black real body.

FIG. 5a shows a candlestick chart with white real body and A-opening price above the white real body.

FIG. 5b shows a candlestick chart with black real body and A-opening price above the black real body.

FIG. 6a shows a candlestick chart with white real body and A-opening price inside the white real body.

FIG. 6b shows a candlestick chart with black real body and A-opening price inside the black real body.

FIG. 7a shows a candlestick chart with white real body and A-opening price below the white real body.

FIG. 7b shows a candlestick chart with black real body and A-opening price below the black real body.

FIG. 8a shows a candlestick chart with white real body and both B-closing price and A-opening price above the white real body.

FIG. 8b shows a candlestick chart with black real body and both B-closing price and A-opening price above the black real body.

FIG. 9a shows a candlestick chart with white real body and both B-closing price inside the white real body and A-opening price above the white real body.

FIG. 9b shows a candlestick chart with black real body and both B-closing price inside the black real body and A-opening price above the black real body.

FIG. 10a shows a candlestick chart with white real body and both B-closing price below the white real body and A-opening price above the white real body.

FIG. 10b shows a candlestick chart with black real body and both B-closing price below the black real body and A-opening price above the black real body.

FIG. 11a shows a candlestick chart with white real body and both B-closing price above the white real body and A-opening price inside the white real body.

FIG. 11b shows a candlestick chart with black real body and both B-closing price above the black real body and A-opening price inside the black real body.

FIG. 12a shows a candlestick chart with white real body and both B-closing price and A-opening price inside the white real body.

FIG. 12b shows a candlestick chart with black real body and both B-closing price and A-opening price inside the black real body.

FIG. 13a shows a candlestick chart with white real body and both B-closing price below the white real body and A-opening price inside the white real body.

FIG. 13b shows a candlestick chart with black real body and both B-closing price below the black real body and A-opening price inside the black real body.

FIG. 14a shows a candlestick chart with white real body and both B-closing price above the white real body and A-opening price below the white real body.

FIG. 14b shows a candlestick chart with black real body and both B-closing price above the black real body and A-opening price below the black real body.

FIG. 15a shows a candlestick chart with white real body and both B-closing price inside the white real body and A-opening price below the white real body.

FIG. 15b shows a candlestick chart with black real body and both B-closing price inside the black real body and A-opening price below the black real body.

FIG. 16a shows a candlestick chart with white real body and both B-closing price and A-opening price below white real body.

FIG. 16b shows a candlestick chart with black real body and both B-closing price and A-opening price below black real body.

FIG. 17 shows a bar chart of prior art.

FIG. 18 shows a new bar chart with B-closing price.

FIG. 19 shows a new bar chart with A-opening price.

FIG. 20 shows a new bar chart with both B-closing price and A-opening price.

### DETAILED DESCRIPTION OF THE INVENTION

While embodiments of this invention will be described below, those skilled in the art will recognize that other price marks and methods are capable of implementing the principles of this invention. Thus the following description is illustrative only and not limiting.

Reference is specifically made to the drawings wherein like numbers are used to designate like members throughout.

An Embodiment of B-closing price and A-opening price of the present invention is the following: B-closing price may be the price at a pre-determined time, for example 30 minutes, before the market closes. A-opening price may be the price at a pre-determined time, for example 30 minutes, after the market opens.

Other embodiment is the following: B-closing price may be the highest price within a pre-determined period of time before the market closes when B-closing price is higher than the closing price. In this embodiment B-closing price shows that, before the market closes, the price drops to close at the closing price. A-opening price may be the highest price within a pre-determined period of time after the market opens when A-opening price is higher than the opening price. In this embodiment A-opening price shows that after the market opens the price goes up.

Another embodiment is that B-closing price may be the lowest price within a pre-determined period of time before the market closes when B-closing price is lower than the closing price. In this embodiment B-closing price shows that, before the market closes, the price goes up to close at the closing price. A-opening price may be the lowest price during a pre-determined period of time after the market opens when A-opening price is lower than the opening price. In this embodiment A-opening price shows that after the market opens the price goes down.

The B-closing price and A-opening price of the present invention may be used, but not limited, to candlestick and bar charts with trading period of time shorter than minute, periods of minute, , hour, day, week, month, year, and period of time longer than a year.

B-closing price is marked by, but not limited to, a dotted line and located on the right hand side of upper and lower shadows and on the right hand side of white and black real bodies. A-opening price is marked by, but not limited to, a dotted line and located on the left hand sides of upper and lower shadows and on the left hand side of white and black real bodies.

On the same chart A-opening price and B-closing price may be different kinds of prices. Different kinds of prices comprise the price at a pre-determined time, the highest price within a pre-determined period of time, and lowest price within a pre-determined period of time.

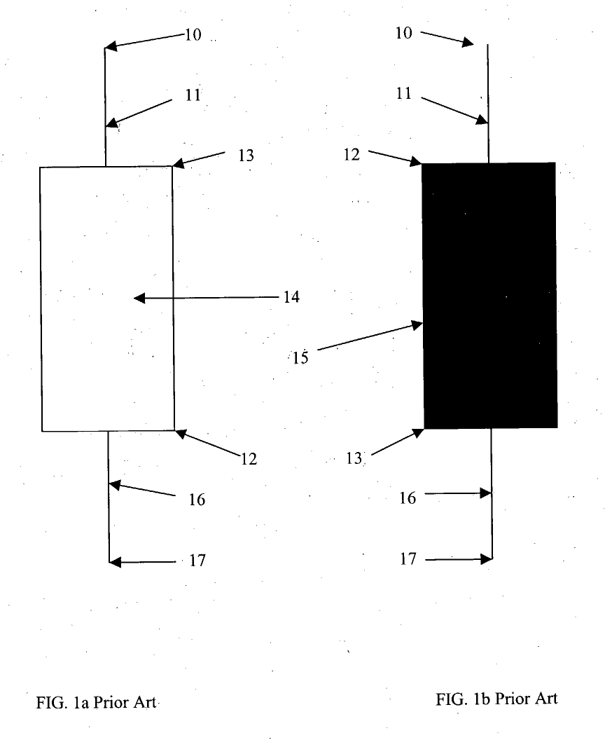

FIG. 1a shows a candlestick chart comprising highest price 10 for a trading period, upper shadow 11, opening price 12, closing price 13 which is higher than opening price 12, white real body 14 which is the price range between opening price 12 and closing price 13, lower shadow 16, lowest price 17 for the trading period.

FIG. 1b shows a candlestick chart comprising highest price 10 for a trading period, upper shadow 11, opening price 12, closing price 13 which is lower than opening price 12, black real body 15 which is the price range between opening price 12 and closing price 13, lower shadow 16, lowest price 17 for the trading period.

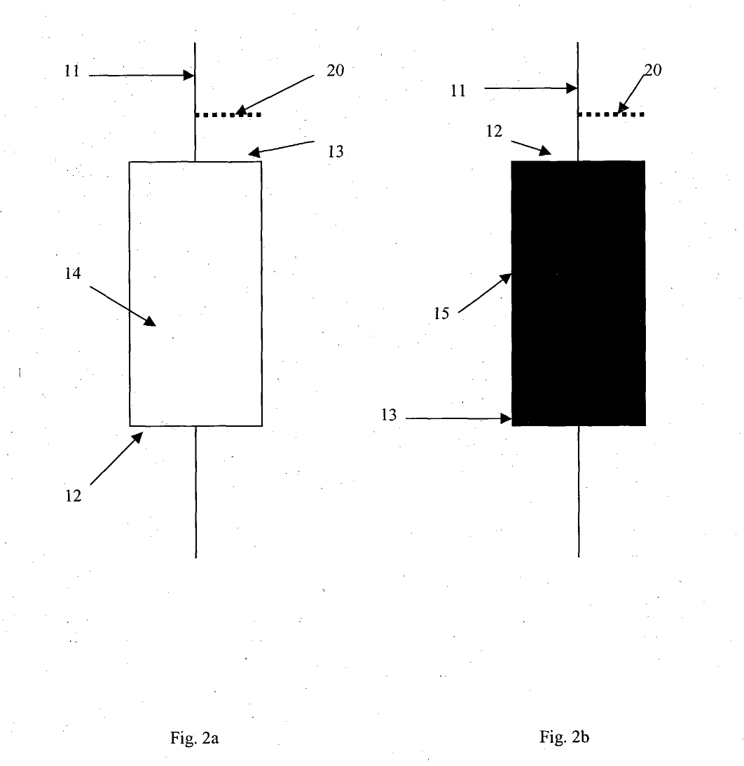

FIG. 2a shows a candlestick chart of the present invention comprising upper shadow 11, opening price 12, closing price 13, white real body 14, B-closing price 20 is the price at a predetermined period of time before the market closes and is in the range of upper shadow 11. The price drops from B-closing price 20 to close at closing price 13.

FIG. 2b shows a candlestick chart of the present invention comprising upper shadow 11, opening price 12, closing price 13, black real body 15, B-closing price 20 is in the range of upper shadow 11. Within a predetermined period of time before the market closes, the price drops from higher than opening price 12 to close at closing price 13. This B-closing price 20 also indicates that the opening price of the next trading period will most likely be lower.

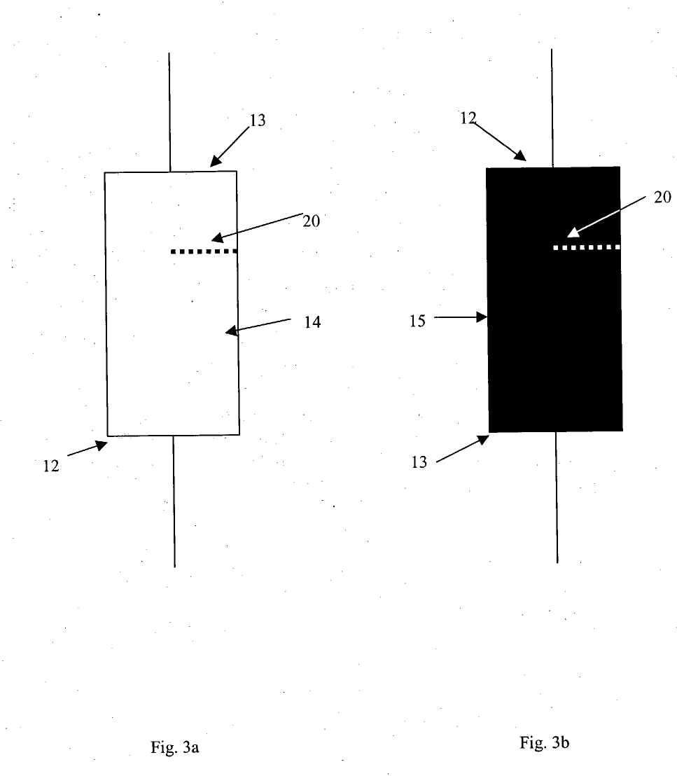

FIG. 3a; shows a candlestick chart of the present invention comprising opening price 12, closing price 13, white real body 14, B-closing price 20 within white real body 14. B-closing price 20 shows that before the market closes, the price goes up to close at closing price 13 which is higher than opening price 12.

FIG. 3b shows a candlestick chart of the present invention comprising opening price 12, closing price 13, black real body 15, B-closing price 20. B-closing price 20 shows that before the market closes the price drops to close at closing price 13 that is lower than opening price 12.

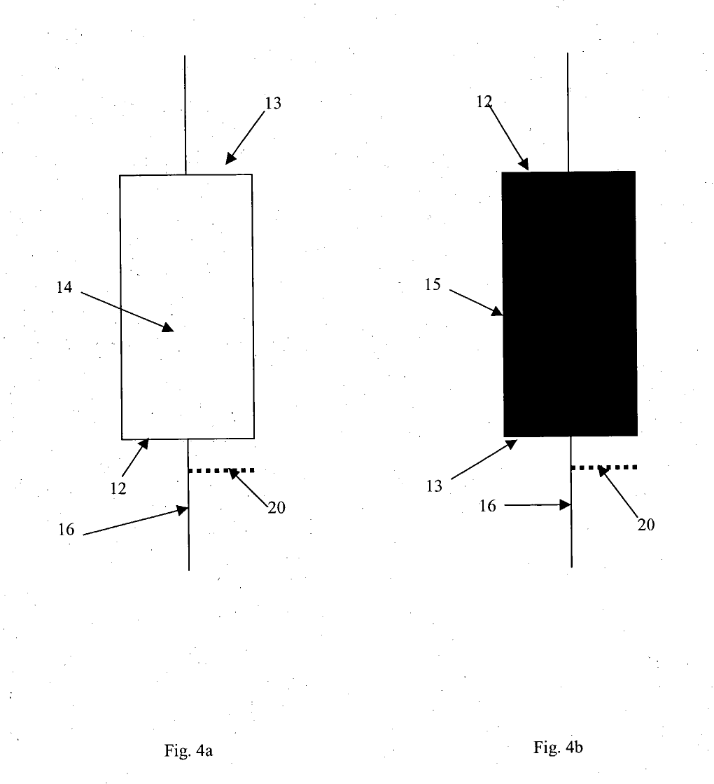

FIG. 4a shows a candlestick chart of the present invention comprising opening price 12, closing price 13, white real body 14, lower shadow 16, B-closing price 20 within lower shadow 16. B-closing price 20 shows that before the market closes, the price goes up to close at closing price 13 which is higher than opening price 12 and that most likely the opening price of the next trading period will be higher.

FIG. 4b shows a candlestick chart of the present invention comprising opening price 12, closing price 13, black real body 15, B-closing price 20. B-closing price 20 shows that before the market closes, the price goes up to close at closing price 13 that is lower than opening price 12.

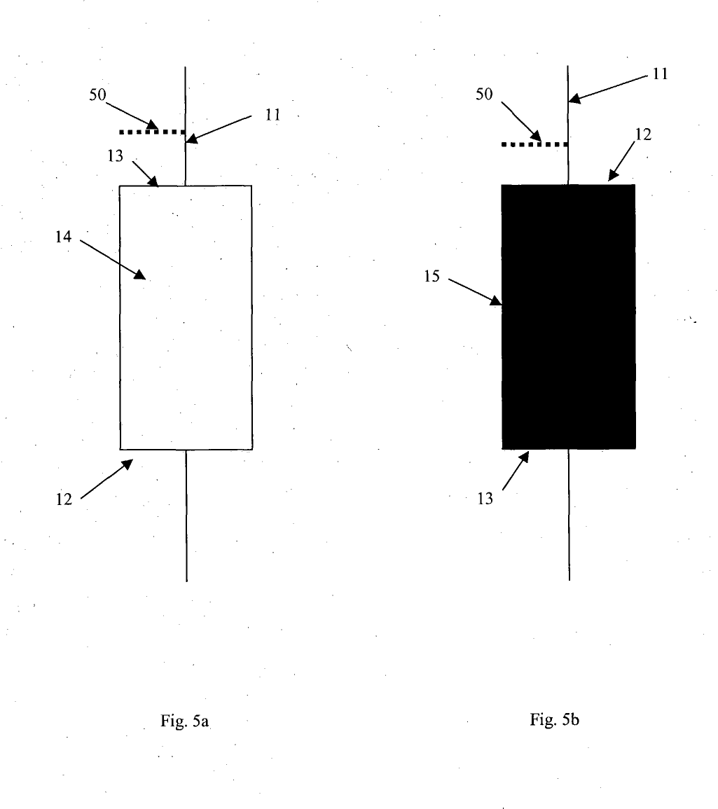

FIG. 5a shows a candlestick chart of the present invention comprising upper shadow 11, opening price 12, closing price 13, white real body 14, A-opening price 50 which is the price for a pre-determined period of time after market opening, is within upper shadow 11, and is on the left hand side of upper shadow. A-opening price 50 shows that after the market opening, the price goes up strongly and higher than closing price 13.

FIG. 5b shows a candlestick chart of the present invention comprising upper shadow 11, opening price 12, closing price 13, black real body 15, A-opening price 50 that is within upper shadow 11. A-opening price 50 shows that after the market opening, the price goes up.

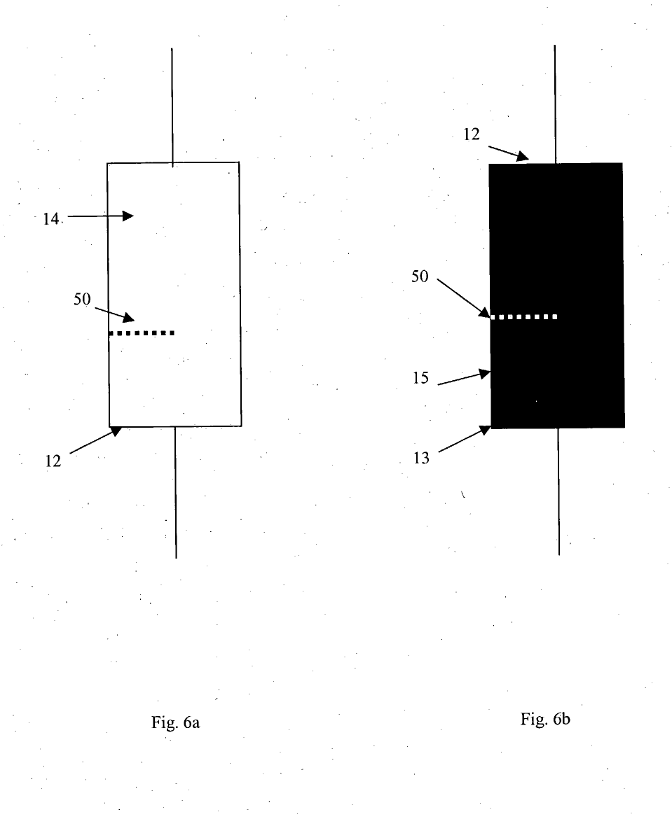

FIG. 6a shows a candlestick chart of the present invention comprising opening price 12, white real body 14, A-opening price 50 that is within white real body 14. A-opening price 50 shows that after the market opening the price goes up.

FIG. 6b shows a candlestick chart of the present invention comprising opening price 12, closing price 13, black real body 15, A-opening price 50 that is within black real body 15. A-opening price 50 shows that after the market opening the price goes down.

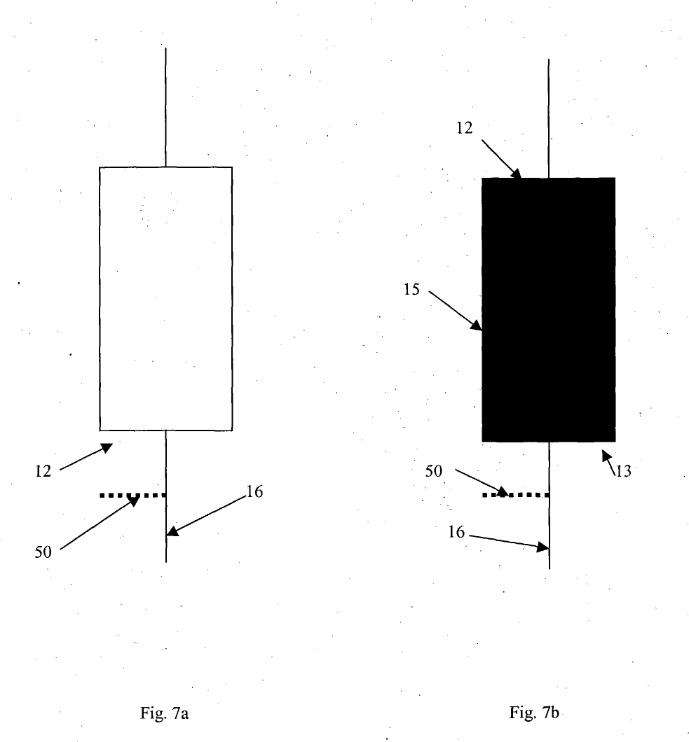

FIG. 7a shows a candlestick chart of the present invention comprising opening price 12, lower shadow 16, A-opening price 50 that is within lower shadow 16. A-opening price 50 shows that after the market opening the price goes down.

FIG. 7b shows a candlestick chart of the present invention comprising opening price 12, lower shadow 16, A-opening price 50 that is within lower shadow 16. A-opening price 50 shows that after the market opening the price goes down sharply to lower than closing price 13 and that most likely the opening price of the next trading period will be lower.

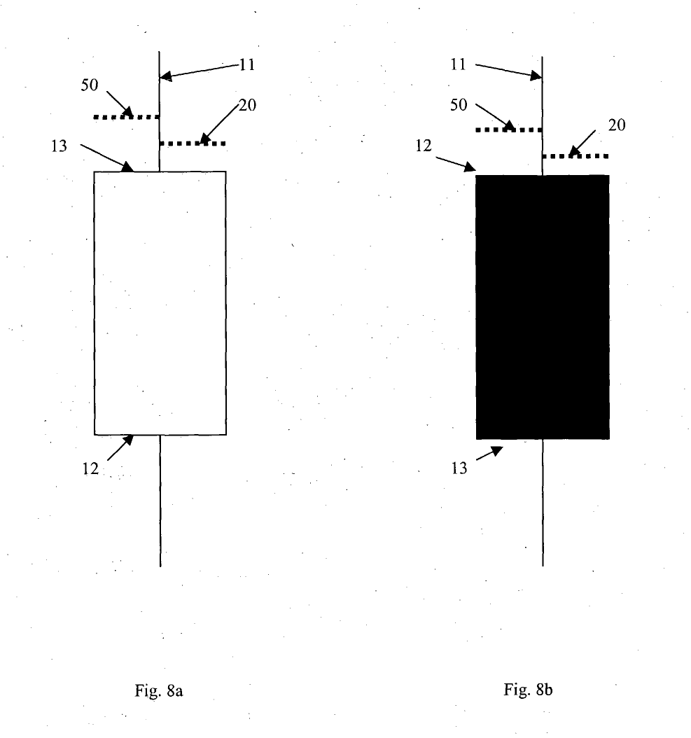

FIG. 8a shows a candlestick chart of the present invention comprising upper shadow 11, opening price 12, closing price 13, B-closing price 20 which is within upper shadow 11, A-opening price 50 which is within upper shadow 11. A-opening price 50 shows that after the market opens the price goes up strongly and higher than closing price 13. B-closing price 20 shows that before the market closing the price goes down to close at closing price 13.

FIG. 8b shows a candlestick chart of the present invention comprising upper shadow 11, opening price 12, closing price 13, B-closing price 20 which is within upper shadow 11, A-opening price 50 which is within upper shadow 11: A-opening price 50 shows that after the market opening the price goes up. B-closing price 20 shows that before the market closes the price goes down sharply from above the opening price 12 to close at closing price 13. Therefore most likely the opening price of the next trading period will be lower.

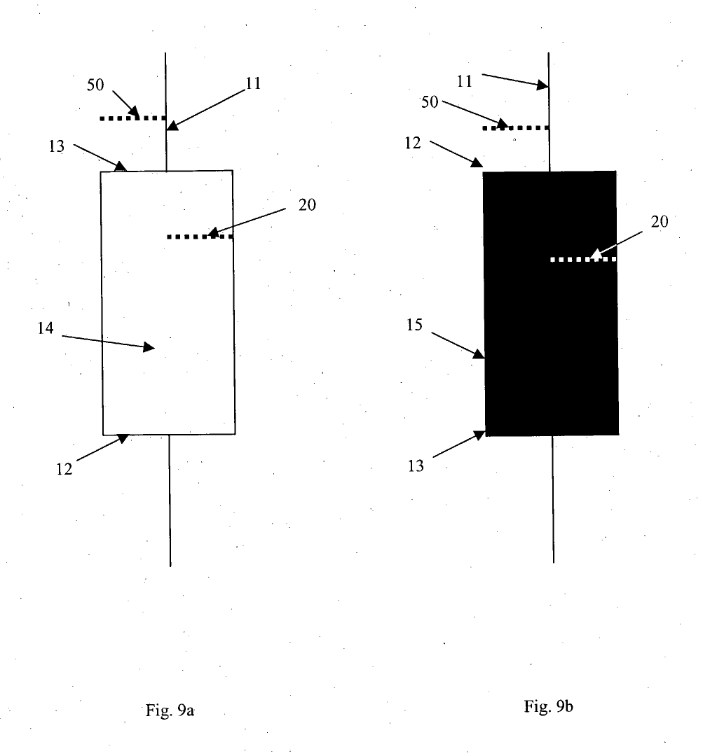

FIG. 9a shows a candlestick chart of the present invention comprising upper shadow 11, opening price 12, closing price 13, white real body 14, B-closing price 20 which is within white real body 14, A-opening price 50 which is within upper shadow 11. A-opening price 50 shows that after the market opens the price goes up strongly and higher than closing price 13. B-closing price 20 shows that before the market closes the price goes up to close at closing price 13.

FIG. 9b shows a candlestick chart of the present invention comprising upper shadow 11, opening price 12, closing price 13, black real body 15, B-closing price 20 which is within black real body 15, A-opening price 50 which is within upper shadow 11. A-opening price 50 shows that after the market opens the price goes up. B-closing price 20 shows that before the market closes the price goes down to close at closing price 13.

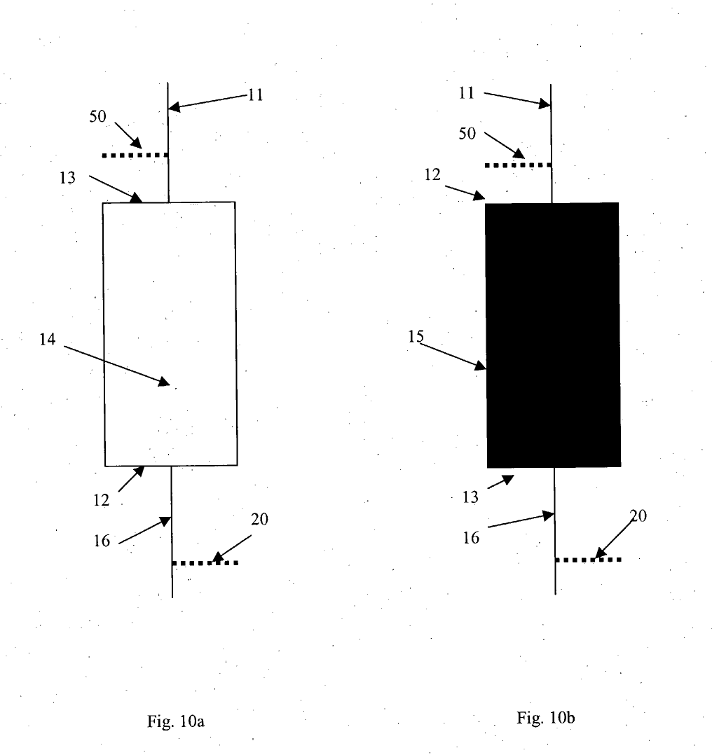

FIG. 10a shows a candlestick chart of the present invention comprising upper shadow 11, opening price 12, closing price 13, white real body 14, B-closing price 20 which is within lower shadow 16, A-opening price 50 which is within upper shadow 11. A-opening price 50 shows that after the market opens the price goes up strongly and is higher than closing price 13. B-closing price 20 shows that before the market closes the price goes up strongly from below opening price 12 to close at closing price 13. Most likely the opening price of the next trading period will be higher.

FIG. 10b shows a candlestick chart of the present invention comprising upper shadow 11, opening price 12, closing price 13, black real body 15, B-closing price 20 which is within lower shadow 16, A-opening price 50 which is within upper shadow 11. A-opening price 50 shows that after the market opens the price goes up. B-closing price 20 shows that before the market closes the price goes up to close at closing price 13.

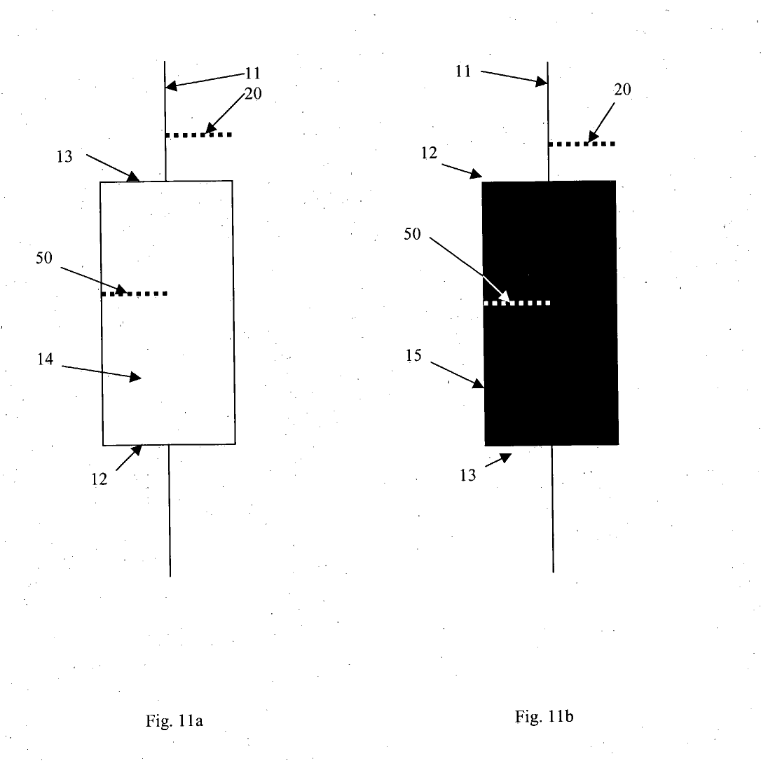

FIG. 11a shows a candlestick chart of the present invention comprising upper shadow 11, opening price 12, closing price 13, white real body 14, B-closing price 20 which is within upper shadow 16, A-opening price 50 which is within white real body 14. A-opening price 50 shows that after the market opens the price goes up. B-closing price 20 shows that before the market closes the price goes down to close at closing price 13.

FIG. 11b shows a candlestick chart of the present invention comprising upper shadow 11, opening,price 12, closing price 13, black real body 15, B-closing price 20 which is within upper shadow 16, A-opening price 50 which is within black real body 15. A-opening price 50 shows that after the market opens the price goes down. B-closing price 20 shows that before the market closes the price goes down poorly from higher than opening price 12 to close at closing price 13. Most likely the opening price of the next trading period will be lower.

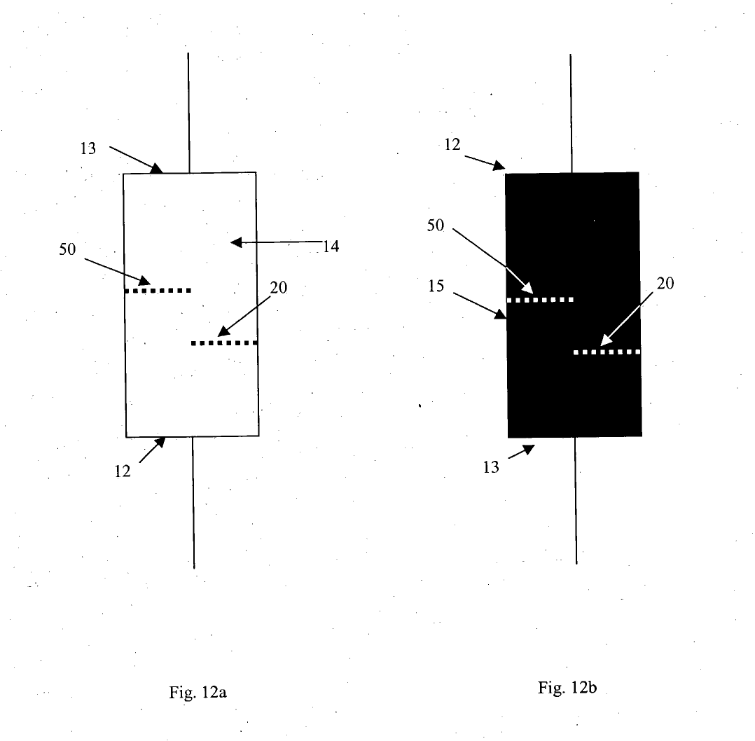

FIG. 12a shows a candlestick chart of the present invention comprising opening price 12, closing price 13, white real body 14, B-closing price 20 which is within white real body 14, A-opening price 50 which is within white real body 14. A-opening price 50 shows that after the market opens the price goes up and is lower than closing price 13. B-closing price 20 shows that before the market closes the price goes up to close at closing price 13.

FIG. 12b shows a candlestick chart of the present invention comprising opening price 12, closing price 13, black real body 15, B-closing price 20 which is within black real body 15, A-opening price 50 which is within black real body 15. A-opening price 50 shows that after the market opens the price goes down. B-closing price 20 shows that before the market closes the price goes down to close at closing price 13.

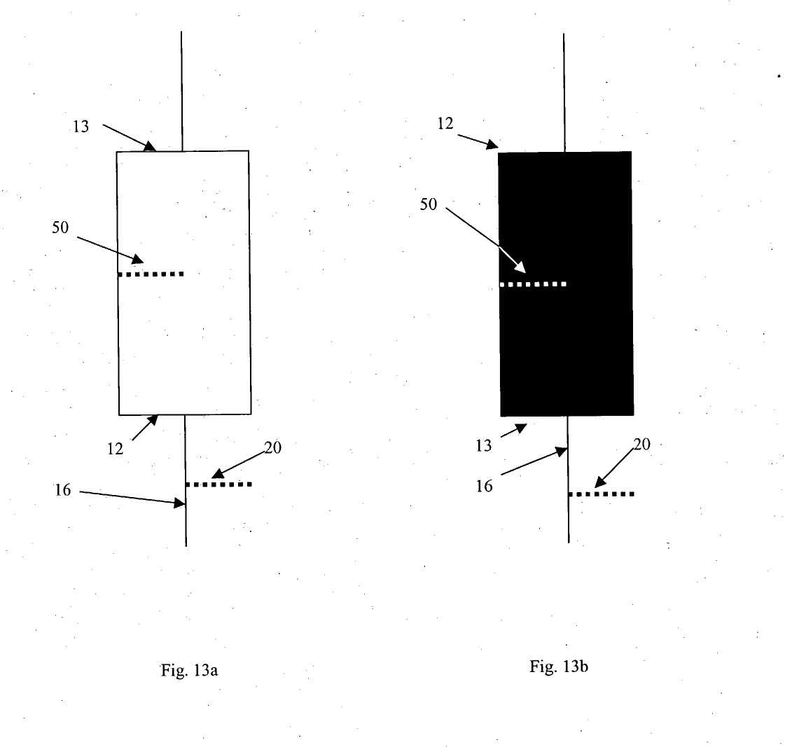

FIG. 13a shows a candlestick chart of the present invention comprising opening price 12, closing price 13, white real body 14, lower shadow 16, B-closing price 20 which is within lower shadow 16, A-opening price 50 which is within white real body 14. A-opening price 50 shows that after the market opens the price goes up and is lower than closing price 13. B-closing price 20 shows that before the market closes the price goes up to close at closing price 13.

FIG. 13b shows a candlestick chart of the present invention comprising opening price 12, closing price 13, black real body 15, lower shadow 16, B-closing price 20 which is within lower shadow 16, A-opening price 50 which is within black real body 15. A-opening price 50 shows that after the market opens the price goes down. B-closing price 20 shows that before the market closes the price goes up to close at closing price 13.

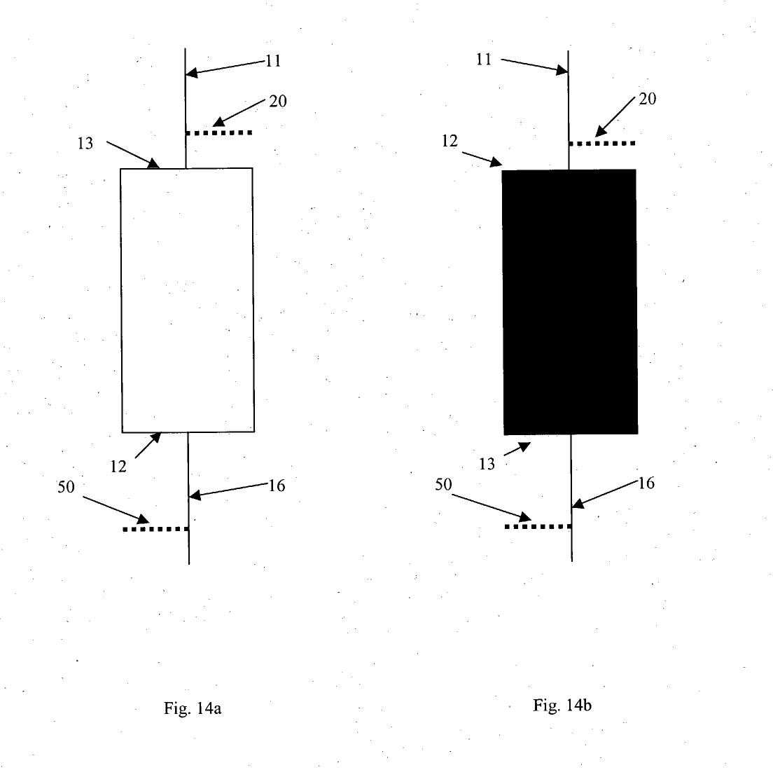

FIG. 14a shows a candlestick chart of the present invention comprising upper shadow 11, opening price 12, closing price 13, white real body 14, lower shadow 16, B-closing price 20 which is within upper shadow 11, A-opening price 50 which is within lower shadowl6. A-opening price 50 shows that after the market opens the price goes down and is lower than opening price 12. B-closing price 20 shows that before the market closes the price goes down to close at closing price 13.

FIG. 14b shows a candlestick chart of the present invention comprising upper shadow 11, opening price 12, closing price 13, lower shadow 16, B-closing price 20 which is within upper shadow 11, A-opening price 50 which is within lower shadowl6. A-opening price 50 shows that after the market opens the price goes down and is lower than closing price 13. B-closing price 20 shows that before the market closes the price goes down to its closing price 13. Most likely the opening price of the next trading period will be lower.

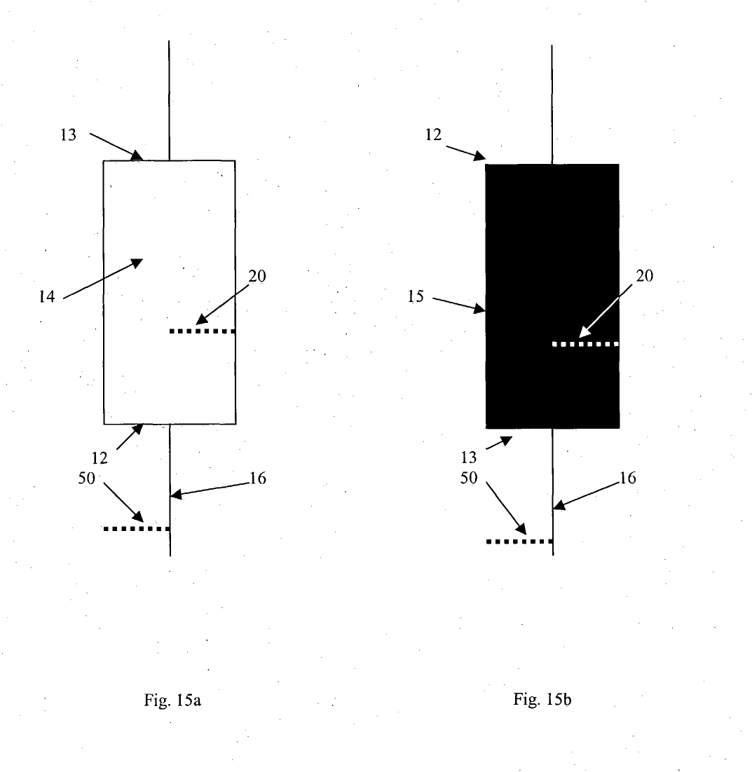

FIG. 15a shows a candlestick chart of the present invention comprising lower shadow 16, opening price 12, closing price 13, white real body 14, B-closing price 20 which is within white real body 14, A-opening price 50 which is within lower shadowl6. A-opening price 50 shows that after the market opens the price goes down and is lower than opening price 12. B-closing price 20 shows that before the market closes the price goes up to close at closing price 13.

FIG. 15b shows a candlestick chart of the present invention comprising lower shadow 16, opening price 12, closing price 13, black real body 15, B-closing price 20 which is within black real body 15, A-opening price 50 which is within lower shadowl6.

A-opening price 50 shows that after the market opens the price goes down and is lower than closing price 13. B-closing price 20 shows that before the market closes the price goes down to close at closing price 13.

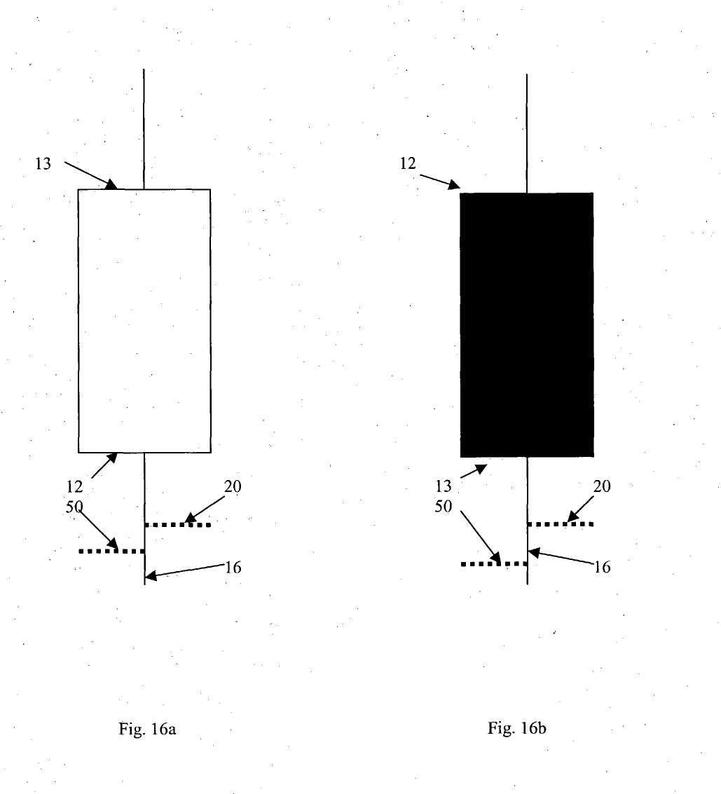

FIG. 16a shows a candlestick chart of the present invention comprising lower shadow 16, opening price 12, closing price 13, B-closing price 20 which is within lower shadow 16, A-opening price 50 which is within lower shadow 16. A-opening price 50 shows that after the market opens the price goes down. B-closing price 20 shows that before the market closes the price goes up sharply to close at closing price 13.

FIG. 16b shows a candlestick chart of the present invention comprising lower shadow 16, opening price 12, closing price 13, B-closing price 20 which is within black real body 15, A-opening price 50 which is within lower shadowl6 6. A-opening price 50 shows that after the market opens the price goes down and is lower than closing price 13. B-closing price 20 shows that before the market closes the price goes up to close at closing price 13.

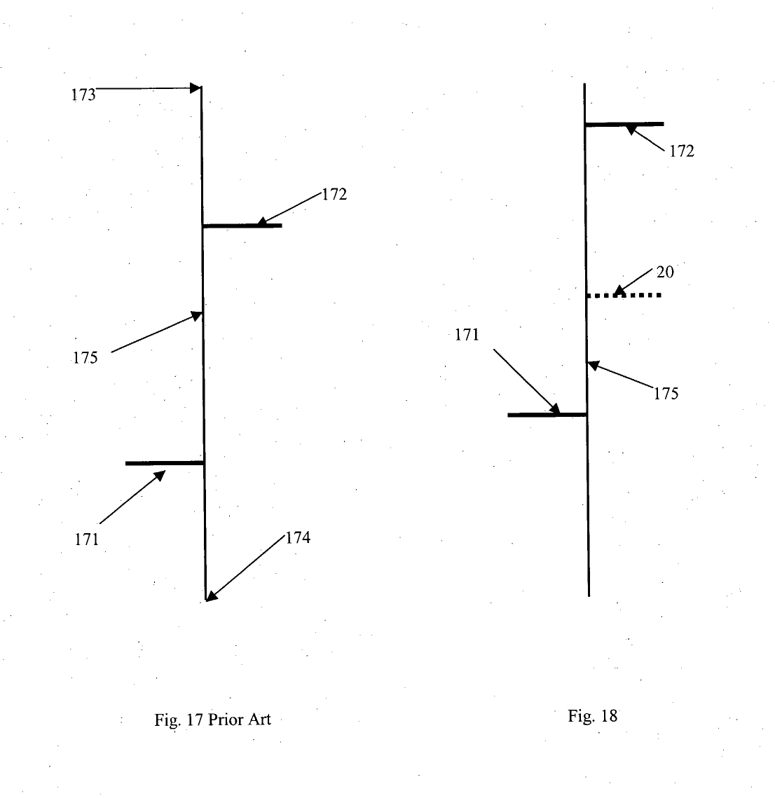

FIG. 17 shows a bar chart of prior art comprising highest price 173 for the trading period, vertical bar 175 which shows the range of prices during the period of trading, opening price 171 which is on the left hand side of vertical bar 175, closing price 172 which is on the right hand side of vertical bar 175, lowest price 174 for the trading period.

FIG. 18 shows a new bar chart of the present invention comprising opening price 171, closing price 172, trading range 175, and B-closing price 20. An embodiment is that B-closing price 20 is lower than closing price 172 as shown in FIG. 18. Another embodiment is that B-closing price 20 is higher than closing price 172.

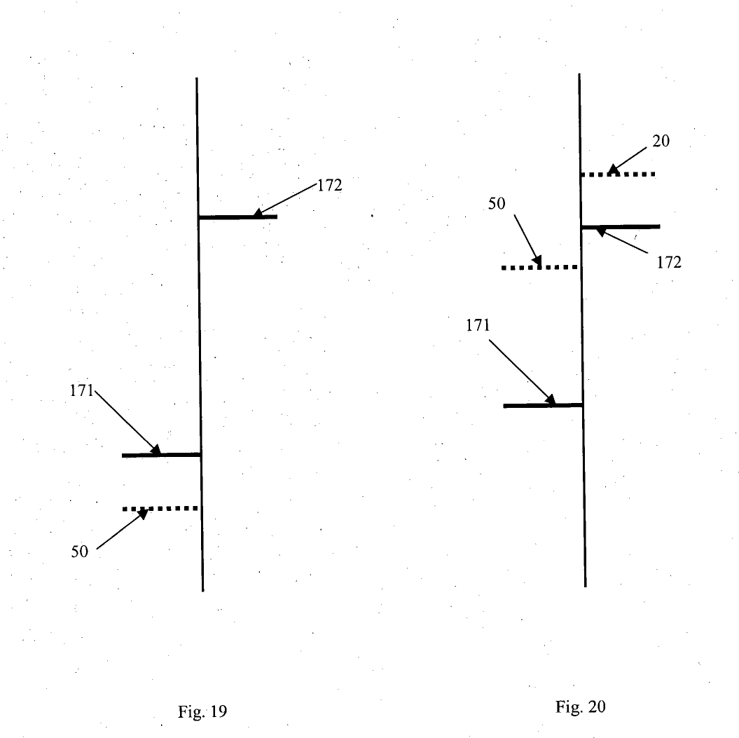

FIG. 19 shows a new bar chart of the present invention comprising opening price 171, closing price 172, and A-opening price 50. An embodiment is that A-opening price 50 is lower than opening price 172 as shown in FIG. 19. Another embodiment is that A-opening price 50 is higher than opening price 172.

FIG. 20 shows an embodiment of a new bar chart of the present invention comprising opening price 171, closing price 172, B-closing price 20 which is higher than closing price 172, and A-opening price 50 which is higher that opening price 171. A-opening price 50 shows that after the market opens the price goes up. B-closing price 20 shows that before the market closes the price goes down to close at closing price 172.

Although the description above contains many specifications, these should not be construed as limiting the scope of the present invention but as merely providing illustrations of some of the presently preferred embodiments of the present invention.

Therefore the scope of the present invention should be determined by the claims and their legal equivalents, rather than by the examples given.

We claim that

1. A new candlestick chart comprising
a. upper shadow
b. lower shadow
c. real body
d. highest price
e. lowest price
f. opening price
g. closing price
h. B-closing price.

2. The new candlestick chart of claim 1 wherein said B-closing price is the price at a pre-determined time before the market closes.

3. The new candlestick chart of claim 1 wherein said B-closing price is the lowest price within a predetermined period of time before the market closes when said B-closing price is lower than said closing price.

4. The new candlestick chart of claim 1 wherein said B-closing price is the highest price within a pre-determined period of time before the market closes when said B-closing price is higher than said closing price.

5. A new candlestick chart comprising
a. upper shadow
b. lower shadow
c. real body
d. highest price
e. lowest price
f. opening price
g. closing price
h. A-opening price.

6. The new candlestick chart of claim 5 wherein said A-opening price is the price at a pre-determined time after the market opens.

7. The new candlestick chart of claim 5 wherein said A-opening price is the lowest price within a pre-determined period of time after the market opens when said A-opening price is lower than said opening price.

8. The new candlestick chart of claim 5 wherein said A-opening price is the highest price within a pre-determined period of time after the market opens when said A-opening price is higher than said opening price.

9. A new candlestick chart comprising
a. upper shadow
b. lower shadow
c. real body
d. highest price
e. lowest price
f. opening price
g. closing price
h. A-opening price
i. B-closing price.

10. The new candlestick chart of claim 9 wherein said A-opening price is the price at a pre-determined time after the market opens.

11. The new candlestick chart of claim 9 wherein said B-closing price is the price at a predetermined time before the market closes.

12. The new candlestick chart of claim 9 wherein said A-opening price is the lowest price within a pre-determined period of time after the market opens when said A-opening price is lower than said opening price.

13. The new candlestick chart of claim 9 wherein said A-opening price is the highest price within a pre-determined period of time after the market opens when said A-opening price is higher than said opening price.

14. The new candlestick chart of claim 9 wherein said B-closing price is the lowest price within a pre-determined period of time before the market closes when said B-closing price is lower than said closing price.

15. The new candlestick chart of claim 9 wherein said B-closing price is the highest price within a pre-determined period of time before the market closes when said B-closing price is higher than said closing price.

16. A new bar chart comprising:
a. opening price
b. closing price
c. highest price
d. lowest price
e. B-closing price.

17. The new bar chart of claim 16 wherein said B-closing price is the price at a pre-determined time before the market closes.

18. The new bar chart of claim 16 wherein said B-closing price is the lowest price within a pre-determined period of time before the market closes when said B-closing price is lower than said closing price.

19. The new bar chart of claim 16 wherein said B-closing price is the highest price within a pre-determined period of time before the market closes when said B-closing price is higher than said closing price.

20. A new bar chart comprising:
a. opening price
b. closing price
c. highest price
d. lowest price
e. A-opening price.

21. The new bar chart of claim 20 wherein said A-opening price is the price at a pre-determined time after the market opens.

22. The new bar chart of claim 20 wherein said A-opening price is the lowest price within a pre-determined period of time after the market opens when said A-opening price is lower than said opening price.

23. The new bar chart of claim 20 wherein said A-opening price is the highest price within a pre-determined period of time after the market opens when said A-opening price is higher than said opening price.

24. A new bar chart comprising
a. upper shadow
b. lower shadow
c. real body
d. highest price
e. lowest price
f. opening price
g. closing price
h. A-opening price
i. B-closing price.

25. The new bar chart of claim 24 wherein said A-opening price is the price at a pre-determined time after the market opens.

26. The new bar chart of claim 24 wherein said B-closing price is the price at a pre-determined time before the market closes.

27. The new bar chart of claim 24 wherein said A-opening price is the lowest price within a pre-determined period of time after the market opens when said A-opening price is lower than said opening price.

28. The new bar chart of claim 24 wherein said A-opening price is the highest price within a pre-determined period of time after the market opens when said A-opening price is higher than said opening price.

29. The new bar chart of claim 24 wherein said B-closing price is the lowest price within a pre-determined period of time before the market closes when said B-closing price is lower than said closing price.

30. The new bar chart of claim 24 wherein said B-closing price is the highest price within a pre-determined period of time before the market closes when said B-closing price is higher than said closing price.
